(19) United States
(12) Patent Application Publication
(10) Pub. No.: US 2026/0182594 A1
(43) Pub. Date: Jul. 2, 2026

(54) Helio-Mil

(71) Applicant: David Lee Bradley, JR., Flint, MI (US)

(72) Inventor: David Lee Bradley, JR., Flint, MI (US)

(21) Appl. No.: 19/007,495

(22) Filed: Jan. 1, 2025

(51) Int. Cl. A23C 11/04; A23L 33/105

(52) U.S. Cl. CPC A23C 11/04; A23L 33/105

(57) ABSTRACT

A non-dairy milk alternative designed for toddlers/infants that struggle with digesting milk. Toddler milk is designed to be a nutrient dense milk alternative that mimics breastmilk, works with the breastmilk and offer children all the nutrients they need to grow into healthy adults.

### BACKGROUND

Recently products like Enfamil and Similac have experienced a lot of problems with bacteria being in their products. This problem caused a lot of recalls and worry in parents. It was not clear at which phase or stage the bacteria was introduced. It could have been introduced in the raw products or a situation where it was a matter of neglect on the parent's behalf (not cleaning bottles correctly). Also, one thing I noticed about milk products for children is that they often include some form of corn syrup. Usually, it is corn maltodextrin but some formulas also have high fructose corn syrup or sugar.

### BRIEF SUMMARY OF INVENTION

Helio-mil is a seed-based milk that is packed with nutrients. Cinnamon was added to address the cronobacter bacteria issue traditional milks are being faced with. A sugar syrup alternative made from Dates was added to address the sweetness. Using certain sweeteners for infants/children can be detrimental to their development. Sweeteners for infants/children are ok when given occasionally but milk is something they drink often. Date syrup offered the sweetness without over doing it and it acted to natural improve digestion. In addition, this will open up the door for research on mushroom, plant (spirulina) and algae-based milk for toddlers and infants. Mushrooms are introduced to assist with immune systems of infants. Bacteria/Viruses are generally passed to infants via the mother's breast milk. By adding mushroom supplements, the goal is to jump start the immune system and work with the mother's immune system to protect the child. Instead of using one system to assist in the child's development, why not use both. The mother's breast milk will introduce nutrients and the mushroom supplement inside of the milk will serve to assist the toddler in fighting off bad diseases that could be passed from the mother to child. Ashwagandha supplement is designed to offset the cortisol that is usually transferred from the mother to child via breast milk. When the child is calmer, it allows the child's body to develop without stress. A calm child, in some cases, leads to a calm mother. A calm mother will then be able to produce better milk. The beet root powder is designed to detox the liver because children don't get to choose their parents and not every parent is responsible. The beet root powder will assist in detoxing harmful toxins from the child body through the liver and improve kidney and digestive tract functions. A part of NEC in premature children comes from dysfunction in the GI-tract. This product may not be able to solve that, but in the event that a premature child is to consume this product there will be an incentive to assist them as well. There isn't much research for Dandelion powder for infants but the general idea for adding this to the mix is to cleanse the blood and keep the urinary tract clean. It is known to balance out hormonal imbalances with adults, I am hoping for the same with the children. However, the primary focus is to clean and rid the body of toxins. Pumpkin seed, Sunflower seed and Flax seed were all selected for various reasons. Because this is a seed-based milk, nutrients may lack and pumpkins are nutrient rich. Sunflower seed was chosen for its fatty acid content. Flax seed were chosen for its Omega-3 and DHA content.

### DETAILED DESCRIPTION

### Toddler Milk Ingredients

1 Cup Sunflower Seed ½ Cup Flax seed ½ Cup Pumpkin seed
½ G of the following: Spirulina, Beet Root Powder, Maitake Mushroom Powder Shitake Mushroom Powder Lions Mane Mushroom Powder and Reishi Mushroom Powder 1.5 Grams Vanilla Powder 2 Grams Cinnamon 1 Gram NutmegAvocado Oil
2 Grams Dandelion Root Powder ¼ Gram Ashwagandha Powder
Nursery Water: 5 Cups total, Dates get 2 cups. 2. cups for seeds and 1 cup for Banana

### Process

Bring Nursery Water to a boil, then add Dandelion root powder and remove from heat. Stir as it seeps until water turns brown.
Add Sunflower seeds, Flax seeds and Pumpkin Seeds to a sheet and spray with avocado oil. Heat in oven at 325 degrees until seeds are warm and aromatic. Add to blender.
Combine the hot/warm Dandelion Root powder water to the blender with the seeds and blend. Allow to seep for 15 minutes then strain using a cheese cloth. Separate milk from byproduct.
Add water, cinnamon stick and dates to a pot and boil until dates begin to soften. The water should begin to change color. Continue to boil and stir until the dates begin to peel apart. Remove from heat and allow to cool. Once cool, strain with a cheese cloth to extract all the syrup and add nutmeg.
Add Banana to water with vanilla bean powder and spirulina. Blend together and strain.
Combine milk, syrup and banana puree mix. Add Ashwagandha, Beet Root Powder, Shitake Mushroom powder, Maitake Mushroom Powder, Reishi Mushroom Powder and Lions Mane Mushroom Powder and blend. Chill and serve or serve warm.

1. Helio-mil is a non-dairy milk alternative packed with nutrients from plant, algae and mushroom milk sweetened organically with fruit.
